(19) United States
(12) Patent Application Publication
(10) Pub. No.: US 2022/0097301 A1
(43) Pub. Date: Mar. 31, 2022

(54) THREE-DIMENSIONAL SHAPING APPARATUS AND THREE-DIMENSIONAL SHAPING SYSTEM

(71) Applicant: SEIKO EPSON CORPORATION, Tokyo (JP)

(72) Inventor: Shusaku FURUYA, Kamina-gun Miyada-mura (JP)

(21) Appl. No.: 17/486,965

(22) Filed: Sep. 28, 2021

(30) Foreign Application Priority Data
Sep. 30, 2020 (JP) 2020-164634

(51) Int. Cl. B29C 64/314; B29C 64/209; B29C 64/295; B29C 64/321; B29C 64/393; B33Y 30/00; B33Y 40/10; B33Y 50/02

(52) U.S. Cl. CPC B29C 64/314; B29C 64/209; B29C 64/295; B33Y 50/02; B29C 64/393; B33Y 30/00; B33Y 40/10; B29C 64/321

(57) ABSTRACT

A three-dimensional shaping apparatus includes a heating block that has a heater and is provided with a through hole, a nozzle tip that is provided with a nozzle flow channel having a nozzle opening and that is detachably attached to the through hole of the heating block, a material conveying mechanism that conveys a material to the nozzle flow channel of a nozzle tip for shaping being the nozzle tip attached to the heating block, a stage at which the material plasticized by heat of the heating block is ejected from the nozzle opening of the nozzle tip for shaping and stacked, and a control unit. The nozzle tip has a shield for suppressing transfer of heat of the heating block to the material stacked at the stage, and the control unit records the nozzle tip for shaping and material information regarding a type of the material in association with each other.

The present application is based on, and claims priority from JP Application Serial Number 2020-164634, filed on Sep. 30, 2020, the disclosure of which is hereby incorporated by reference herein in its entirety.

### BACKGROUND

### 1. Technical Field

The present disclosure relates to a three-dimensional shaping apparatus and a three-dimensional shaping system.

### 2. Related Art

With respect to a three-dimensional shaping apparatus, for example, JP-A-2006-192710 (Patent Document 1) discloses an apparatus for shaping a three-dimensional shaped article by extruding a molten thermoplastic material on a base stand from a nozzle that performs scanning according to preset shape data, and further stacking the molten material on the material hardened on the base stand.

In the apparatus disclosed in Patent Document 1, heat of a heater for melting the material may be transferred to the three-dimensional shaped article on the base stand to deform the three-dimensional shaped article. In addition, the material may be deposited on a wall face of a nozzle flow channel due to use over time to cause nozzle clogging. This nozzle clogging is particularly likely to occur when multiple materials having different melting temperatures are ejected from one nozzle.

### SUMMARY

According to a first aspect of the present disclosure, a three-dimensional shaping apparatus is provided. The three-dimensional shaping apparatus includes a heating block that has a heater and is provided with a through hole, a nozzle tip that is provided with a nozzle flow channel having a nozzle opening and that is detachably attached to the through hole of the heating block, a material conveying mechanism that conveys a material to the nozzle flow channel of a nozzle tip for shaping being the nozzle tip attached to the heating block, a stage at which the material plasticized by heat of the heating block is ejected from the nozzle opening of the nozzle tip for shaping and stacked, and a control unit. The nozzle tip has a shield for suppressing transfer of heat of the heating block to the material stacked at the stage, and the control unit records the nozzle tip for shaping and material information regarding a type of the material in association with each other.

According to a second aspect of the present disclosure, a three-dimensional shaping system including multiple three-dimensional shaping apparatuses and a control device that controls the multiple three-dimensional shaping apparatuses is provided. In the three-dimensional shaping system, each three-dimensional shaping apparatus includes a heating block that has a heater and is provided with a through hole, a nozzle tip that is provided with a nozzle flow channel having a nozzle opening and that is detachably attached to the through hole of the heating block, a material conveying mechanism that conveys a material to the nozzle flow channel of a nozzle tip for shaping being the nozzle tip attached to the heating block, a stage at which the material plasticized by heat of the heating block is ejected from the nozzle opening of the nozzle tip for shaping and stacked, and a communication unit that communicates with the control device. The nozzle tip has a shield for suppressing transfer of heat of the heating block to the material stacked at the stage, and the communication unit transmits nozzle information regarding information for identifying the nozzle tip for shaping and material information regarding a type of the material to the control device. The control device records the material information and the nozzle information in association with each other.

### BRIEF DESCRIPTION OF THE DRAWINGS

FIG. 1 is a view showing a schematic configuration of a three-dimensional shaping apparatus according to a first embodiment.

FIG. 2 is a view showing a schematic configuration of a material holding portion and an ejection portion of the first embodiment.

FIG. 3 is a schematic perspective view showing a configuration of a screw at a grooved face side.

FIG. 4 is a top view showing a configuration of a barrel at a screw opposed face side.

FIG. 5 is a view for illustrating the attachment/detachment of a nozzle tip to/from a through hole.

FIG. 6 is a process chart showing a three-dimensional shaping process in the first embodiment.

FIG. 7 is a process chart showing a material difference determination process in the first embodiment.

FIG. 8 is a process chart showing a cumulative ejection amount updating process in the first embodiment.

FIG. 9 is a process chart showing a three-dimensional shaping process in a second embodiment.

FIG. 10 is a process chart showing a block difference determination process.

FIG. 11 is a process chart showing a three-dimensional shaping process in a third embodiment.

FIG. 12 is a process chart showing an apparatus difference determination process.

FIG. 13 is a view showing a schematic configuration of a three-dimensional shaping apparatus according to a fourth embodiment.

FIG. 14 is a view for illustrating a schematic configuration of an ejection portion of the fourth embodiment.

FIG. 15 is a schematic block diagram showing a configuration of a three-dimensional shaping system as a fifth embodiment.

FIG. 16 is a process chart showing an example of a three-dimensional shaping process in the fifth embodiment.

FIG. 17 is a process chart showing material difference determination in the fifth embodiment.

FIG. 18 is a process chart showing a cumulative ejection amount updating process in the fifth embodiment.

### DESCRIPTION OF EXEMPLARY EMBODIMENTS

### A. First Embodiment

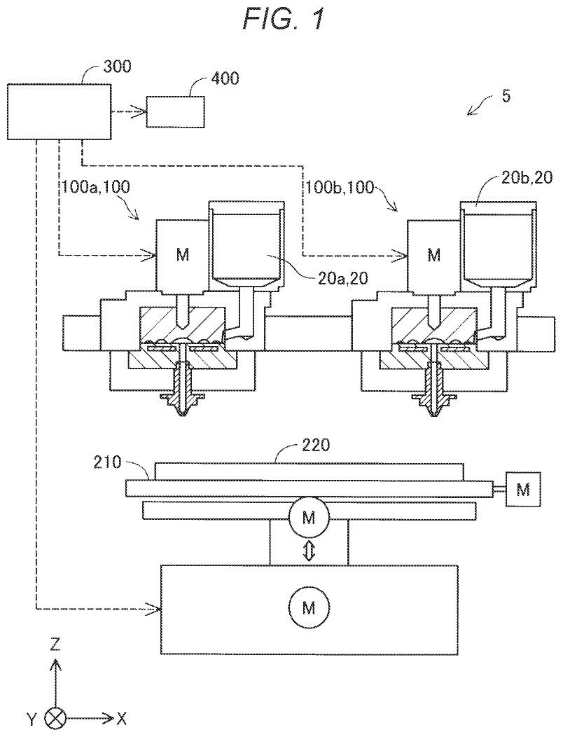

FIG. 1 is a view showing a schematic configuration of a three-dimensional shaping apparatus 5 according to a first embodiment. In FIG. 1, arrows along X, Y, and Z directions orthogonal to one another are illustrated. The X, Y, and Z directions are directions along an X axis, a Y axis, and a Z axis that are three spatial axes orthogonal to one another, and each includes both of one side direction along the X axis, Y axis, or Z axis and a direction opposite thereto. The X axis and Y axis are axes along a horizontal plane, and the Z axis is an axis along a vertical line. In other drawings, arrows along the X, Y, and Z directions are also illustrated as appropriate. The X, Y, and Z directions in FIG. 1 and the X, Y, and Z directions in the other drawings indicate the same directions, respectively.

The three-dimensional shaping apparatus 5 of this embodiment includes a first ejection portion 100a, a second ejection portion 100b, a first material holding portion 20a, a second material holding portion 20b, a moving mechanism portion 210, a stage 220, a control unit 300, and a notification portion 400. Hereinafter, when the first ejection portion 100a and the second ejection portion 100b are described without particularly making a distinction between them, these portions are sometimes simply referred to as “ejection portion 100”. Similarly, when the first material holding portion 20a and the second material holding portion 20b are described without particularly making a distinction between them, these portions are sometimes simply referred to as “material holding portion 20”.

The moving mechanism portion 210 changes the relative position of the ejection portion 100 and the stage 220. In this embodiment, the moving mechanism portion 210 moves the stage 220 with respect to the first ejection portion 100a and the second ejection portion 100b. The change of the relative position of the first ejection portion 100a or the second ejection portion 100b with respect to the stage 220 is sometimes simply referred to as movement of the first ejection portion 100a or the second ejection portion 100b. The moving mechanism portion 210 in this embodiment is constituted by a three-axis positioner for moving the stage 220 in three axis directions of the X, Y, and Z directions by the driving forces of three motors. Each motor drives under the control of the control unit 300. In other embodiments, the moving mechanism portion 210 may, for example, be configured to move the ejection portion 100 without moving the stage 220 instead of being configured to move the stage 220. In addition, the moving mechanism portion 210 may be configured to move both the stage 220 and the ejection portion 100.

The control unit 300 is constituted by a computer including one or more processors, a main memory device, and an input/output interface for performing signal input/output to/from the outside. In this embodiment, the control unit 300 exhibits various functions such as a function of executing a three-dimensional shaping process for shaping a three-dimensional shaped article by executing a program or a command read in the main memory device by the processor. The control unit 300 may be constituted by a combination of multiple circuits instead of a computer.

The notification portion 400 of this embodiment is constituted by a liquid crystal monitor and notifies information by displaying visual information on the liquid crystal monitor. The notification portion 400 notifies, for example, the control state or the like of the three-dimensional shaping apparatus 5 as the information. In other embodiments, the notification portion 400 may be constituted by another device that notifies visual information, or may be constituted by a device that notifies information other than visual information such as voice information.

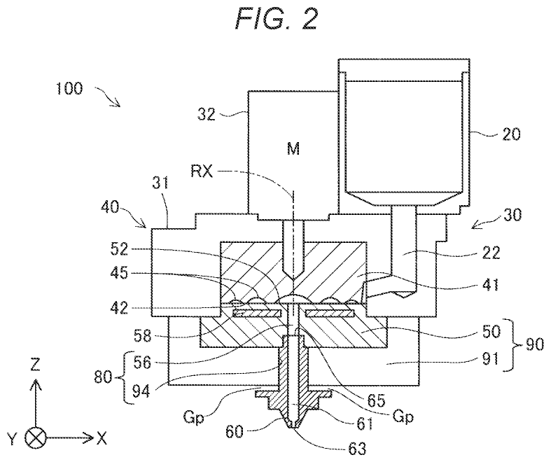

FIG. 2 is a view showing a schematic configuration of the material holding portion 20 and the ejection portion 100 of this embodiment. In FIG. 2, the configurations of the first material holding portion 20a and the first ejection portion 100a are shown. The configurations of the second material holding portion 20b and the second ejection portion 100b are the same as the configurations of the first material holding portion 20a and the first ejection portion 100a, respectively, unless otherwise specified. Hereinafter, when a constituent element related to the first ejection portion 100a and a constituent element related to the second ejection portion 100b are described while making a distinction between them, for the constituent element related to the first ejection portion 100a, “a” is attached to the end of the reference numeral, and for the constituent element related to the second ejection portion 100b, “b” is attached to the end of the reference numeral. When a constituent element of the first ejection portion 100a and a constituent element of the second ejection portion 100b are described without particularly making a distinction between them, the elements are described without attaching “a” or “b” to the end of the reference numeral.

As described above, the ejection portion 100 includes a plasticizing portion 30 and a nozzle tip 60. The plasticizing portion 30 has a material conveying mechanism 40 and a heating block 90. To the ejection portion 100, a material held in the material holding portion 20 is supplied. More specifically, to the first ejection portion 100a, a first material held in the first material holding portion 20a is supplied, and to the second ejection portion 100b, a second material held in the second material holding portion 20b is supplied. The ejection portion 100 plasticizes at least a part of the material supplied from the material holding portion 20 by the plasticizing portion 30, and ejects the plasticized material onto the stage 220 from the nozzle tip 60 and stacks the material thereon under the control of the control unit 300. The material stacked on the stage 220 is sometimes referred to as “stacked material”. Further, a three-dimensional shaping method for shaping a three-dimensional shaped article by ejecting a material from a nozzle and stacking the ejected material is sometimes referred to as a material extrusion method (ME: Material Extrusion).

The “plasticizing” means melting by applying heat to a material having thermoplasticity. The “melting” not only means transforming a material having thermoplasticity into a liquid by heating the material to a temperature equal to or higher than the melting point, but also means softening a material having thermoplasticity by heating the material to a temperature equal to or higher than the glass transition point so as to exhibit fluidity. The temperature at which the fluidity of a material is exhibited is sometimes referred to as the “melting temperature” of the material.

In the material holding portion 20 of this embodiment, a material in a state of a pellet, a powder, or the like is stored. In this embodiment, a material stored in the material holding portion 20 is a resin in a pellet form. The material holding portion 20 of this embodiment is constituted by a hopper. The material stored in the material holding portion 20 is supplied to the material conveying mechanism 40 of the plasticizing portion 30 of the ejection portion 100 through a supply channel 22 provided below the material holding portion 20 so as to couple the material holding portion 20 to the ejection portion 100. In this embodiment, the first material is stored in the first material holding portion 20a, and the first material is supplied to the first material conveying mechanism 40a of the first ejection portion 100a. The second material is stored in the second material holding portion 20b, and the second material is supplied to the second material conveying mechanism 40b of the second ejection portion 100b.

The first material of this embodiment is a material for shaping a three-dimensional shaped article having an intended shape, and is sometimes referred to as “shaping material”. The second material is a material for supporting the three-dimensional shaped article, and is sometimes referred to as “support material”. Specifically, the support material holds the shape of the shaped article in the middle of shaping by supporting the shaping material in the shaping of the three-dimensional shaped article. A user can obtain the three-dimensional shaped article having an intended shape by removing the support material from the three-dimensional shaped article after completion of the three-dimensional shaped article. The support material is removed by, for example, physically detaching it from a portion shaped by the shaping material of the three-dimensional shaped article. The support material that is soluble in a liquid such as water is sometimes particularly referred to as “soluble support material”.

The heating block 90 has a heater 58. Further, the heating block 90 is provided with a through hole 80. The through hole 80 is configured to be able to attach and detach the nozzle tip 60 thereto and therefrom. The material conveying mechanism 40 conveys the material to a nozzle flow channel 61 of the nozzle tip 60 attached to the through hole 80 of the heating block 90. The nozzle tip 60 attached to the heating block 90 is sometimes referred to as “nozzle tip for shaping”. Further, a state where the nozzle tip 60 is attached to the heating block 90 is sometimes referred to as “attached state”. The plasticizing portion 30 conveys the material supplied to the material conveying mechanism 40 from the material holding portion 20 to the nozzle flow channel 61 of the nozzle tip for shaping by the material conveying mechanism 40, and plasticizes the material through heating by heat of the heating block 90.

The material conveying mechanism 40 of this embodiment includes a screw case 31, a screw 41 stored in the screw case 31, and a driving motor 32 that drives the screw 41. The heating block 90 of this embodiment includes a case portion 91 having an opening portion 94, and a barrel 50 disposed in the case portion 91. The barrel 50 is provided with a communication hole 56. The through hole 80 of this embodiment is formed by allowing the opening portion 94 and the communication hole 56 to communicate with each other. Further, the heater 58 is specifically incorporated in the barrel 50. The screw 41 of this embodiment is a so-called flat screw, and is sometimes referred to as “scroll”.

The screw 41 has a substantially columnar shape whose height in a direction along its central axis RX is smaller than the diameter. The screw 41 has a grooved face 42 having a screw groove 45 formed therein at a face opposed to the barrel 50. Specifically, the grooved face 42 is opposed to a screw opposed face 52 of the barrel 50 to be described later. The central axis RX of this embodiment coincides with the rotational axis of the screw 41. A detailed configuration of the screw 41 at the grooved face 42 side will be described later.

The drive motor 32 is coupled to a face at an opposite side to the grooved face 42 of the screw 41. The drive motor 32 is driven under the control of the control unit 300. The screw 41 is rotated around the central axis RX by a torque generated by rotation of the drive motor 32. The drive motor 32 need not be directly coupled to the screw 41, and may be coupled through, for example, a decelerator.

The barrel 50 has a screw opposed face 52 opposed to the grooved face 42 of the screw 41. The case portion 91 is disposed so as to cover a face opposite side to the screw opposed face 52 of the barrel 50, that is, the lower face of the barrel 50. The communication hole 56 and the opening portion 94 are provided at a position overlapped with the central axis RX of the screw 41. That is, the through hole 80 is located at a position overlapped with the central axis RX.

The nozzle tip 60 is detachably attached to the through hole 80 of the heating block 90 as described above. The nozzle tip 60 is provided with the nozzle flow channel 61 described above. The nozzle flow channel 61 has a nozzle opening 63 at the front end of the nozzle tip 60, and a flow inlet 65 at the rear end of the nozzle tip 60. In this embodiment, the nozzle opening 63 is located at a position in the −Z direction of the flow inlet 65. The nozzle tip 60 of this embodiment ejects the material flowing in the nozzle flow channel 61 through the through hole 80 and the flow inlet 65 to the stage 220 from the nozzle opening 63.

In this embodiment, the first nozzle tip 60a is attached to the first heating block 90a of the first ejection portion 100a and ejects the first material supplied from the first material holding portion 20a. That is, the first nozzle tip 60a of this embodiment is the nozzle tip 60 that ejects the material for forming the intended shape, and is sometimes referred to as “main tip”. The second nozzle tip 60b is attached to the second heating block 90b of the second ejection portion 100b and ejects the second material supplied from the second material holding portion 20b. That is, the second nozzle tip 60b of this embodiment is the nozzle tip 60 that ejects the material for holding the shape of the shaped article in the middle of shaping, and is sometimes referred to as “tip for a support”. The nozzle tip 60 that ejects the soluble support material is sometimes particularly referred to as “tip for a soluble support”.

For example, even if the first material and the second material are the same material, the first nozzle tip 60a can be used as the main tip, and the second nozzle tip 60b can be used as the tip fora support. In this case, the control unit 300 may, for example, control the first heating block 90a under a temperature condition suitable for ejecting the material for forming the intended shape, or the like, and control the second heating block 90b under such a temperature condition that the condition is suitable for reinforcing the shape of the shaped article in the middle of shaping, and also the material ejected for a support is easily detached after completion of the three-dimensional shaped article, or the like.

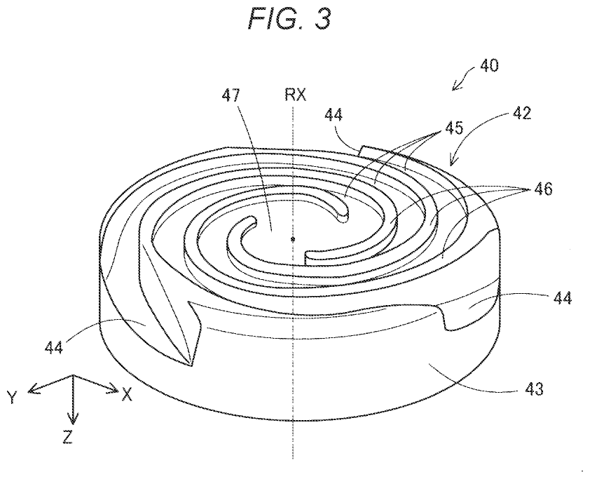

FIG. 3 is a schematic perspective view showing a configuration of the screw 41 at the grooved face 42 side. In FIG. 3, the position of the central axis RX of the screw 41 is indicated by a long dashed short dashed line. As described above, in the grooved face 42, the screw groove 45 is provided. A screw central portion 47 that is a central portion of the grooved face 42 of the screw 41 is configured as a recess to which one end of the screw groove 45 is coupled. The screw central portion 47 is opposed to the communication hole 56 of the barrel 50 shown in FIG. 1. The screw central portion 47 crosses the central axis RX.

The screw groove 45 of the screw 41 constitutes a so-called scroll groove. The screw groove 45 extends in a spiral shape so as to draw an arc toward the outer circumference of the screw 41 from the screw central portion 47. The screw groove 45 may be configured to extend in an involute curve shape or in a helical shape. In the grooved face 42, a projecting ridge portion 46 that constitutes a side wall portion of the screw groove 45 and that extends along each screw groove 45 is provided. The screw groove 45 continues to a material inlet 44 formed in a side face 43 of the screw 41. This material inlet 44 is a portion for receiving the material supplied through the supply channel 22 of the material holding portion 20.

In FIG. 3, an example of the screw 41 having three screw grooves 45 and three projecting ridge portions 46 is shown. The number of screw grooves 45 or projecting ridge portions 46 provided in the screw 41 is not limited to 3, and only one screw groove 45 may be provided, or two or more multiple screw grooves 45 may be provided. Further, in FIG. 3, an example of the screw 41 in which the material inlet 44 is formed at three sites is shown. The number of sites at which the material inlet 44 is provided in the screw 41 is not limited to 3, and the material inlet 44 may be provided at only one site or may be provided at two or more multiple sites.

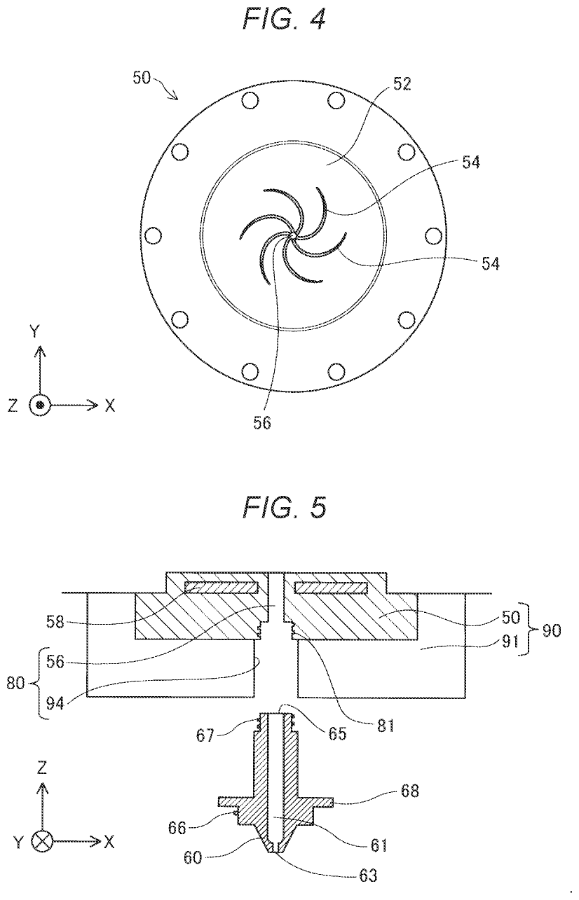

FIG. 4 is a top view showing a configuration of the barrel 50 at the screw opposed face 52 side. As described above, at the center of the screw opposed face 52, the communication hole 56 is formed. Around the communication hole 56 in the screw opposed face 52, multiple guide grooves 54 are formed. One end of each of the guide grooves 54 is coupled to the communication hole 56, and each guide groove 54 extends in a spiral shape toward the outer circumference of the screw opposed face 52 from the communication hole 56. Each guide groove 54 has a function of guiding the shaping material to the communication hole 56. One end of the guide groove 54 need not be coupled to the communication hole 56. Further, in the barrel 50, the guide groove 54 need not be formed.

FIG. 5 is a view for illustrating the attachment/detachment of the nozzle tip 60 to/from the through hole 80. In FIG. 5, the nozzle tip 60 in a state of being detached from the through hole 80 is shown. In this embodiment, a nozzle threaded portion 67 is formed in a portion to be coupled to the through hole 80 of the nozzle tip 60, and a through hole threaded portion 81 to be screwed to the nozzle threaded portion 67 is provided in a portion to be coupled to the nozzle tip 60 of the through hole 80. The nozzle tip 60 is attached to the heating block 90 by inserting the nozzle tip 60 into the through hole 80 and screwing the nozzle threaded portion 67 and the through hole threaded portion 81 to each other. Further, the nozzle tip 60 is detached from the heating block 90 by unscrewing the nozzle threaded portion 67 and the through hole threaded portion 81 from each other and pulling out the nozzle tip 60 from the through hole 80. In this embodiment, the nozzle tip 60 is located below the barrel 50 and attached to the heating block 90 so that the communication hole 56 and the nozzle flow channel 61 communicate with each other.

The nozzle tip 60 has a shield 68. The shield 68 suppresses transfer of heat of the heating block 90 to the stacked material. Specifically, the shield 68 is formed as a portion having a larger area of the cross section along the X direction and the Y direction as compared to the other portions in the Z direction that is a direction along the nozzle flow channel 61. The shield 68 suppresses heat transfer to the stacked material from the heating block 90 by being located between the heating block 90 and the stacked material in the attached state.

The shield 68 is, for example, formed of stainless steel or the like generally having a low emissivity. The shield 68 may be formed of, for example, a material other than stainless steel, and for example, by forming the shield 68 from aluminum or the like having a lower emissivity than stainless steel, an effect of suppressing heat transfer to the stacked material by thermal radiation of the heating block 90 is further enhanced. In addition, for example, by forming the shield 68 from polytetrafluoroethylene (PTFE) or the like generally having a low thermal conductivity, thermal conduction to the shield 68 from the heating block 90 is further suppressed. The shield 68 may be formed integrally with the nozzle tip 60 or may be formed as a separate body. Further, the shield 68 may be formed of multiple materials.

As shown in FIG. 2, in this embodiment, a gap Gp is formed between the shield 68 and the heating block 90. The gap Gp suppresses the thermal conduction to the shield 68 from the heating block 90 and further enhances the effect of suppressing heat transfer to the stacked material from the heating block 90 by the shield 68. In other embodiments, the gap Gp need not be formed between the shield 68 and the heating block 90, that is, the shield 68 and the heating block 90 may be in direct contact with each other.

As shown in FIG. 5, the nozzle tip 60 of this embodiment has a memory portion 66 constituted by an IC chip as a memory medium. In the memory portion 66 of this embodiment, material information and a cumulative ejection amount are recorded by the control unit 300. The material information is information regarding the type of material. The cumulative ejection amount is a cumulative value of the amount of the material ejected after the nozzle tip 60 is attached to the heating block 90 for the first time. The memory portion 66 of this embodiment is electrically coupled to the control unit 300 through an unillustrated wiring and an unillustrated coupling portion by attaching the nozzle tip 60 to the heating block 90.

The memory portion 66 is located between the nozzle opening 63 and the shield 68 in the Z direction that is a direction along the nozzle flow channel 61. According to this, the shield 68 is located between the memory portion 66 and the heating block 90 in the attached state. Therefore, heat transfer to the memory portion 66 from the heating block 90 is suppressed by the shield 68 in the same manner as heat transfer to the stacked material from the heating block 90 is suppressed by the shield 68.

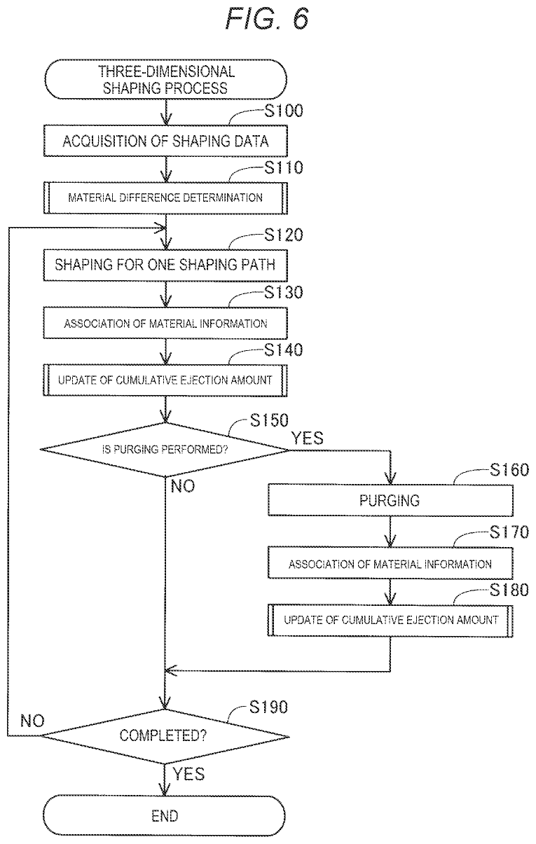

FIG. 6 is a process chart showing a three-dimensional shaping process in this embodiment. The three-dimensional shaping process refers to a process for shaping a three-dimensional shaped article. The control unit 300, for example, starts the three-dimensional shaping process when it receives a start command by a user through an unillustrated input portion or the like. In this embodiment, the control unit 300 controls, in the three-dimensional shaping process, the ejection portion 100 and the moving mechanism portion 210 based on the below-mentioned shaping data so as to move the nozzle tip for shaping that is the nozzle tip 60 attached to the heating block 90 with respect to the stage 220 and eject the plasticized material to the stage 220 from the nozzle tip for shaping, thereby stacking the plasticized material on the stage 220. More specifically, the control unit 300 shapes a three-dimensional shaped article by solidifying the plasticized material ejected onto the stage 220 and forming a layer of the material. The “solidifying the material” means that the ejected plasticized material loses its fluidity. In this embodiment, the shaping material is thermally contracted and also loses its plasticity by cooling and thus is solidified.

In Step S100, the control unit 300 acquires shaping data. The control unit 300 acquires shaping data from, for example, an external computer or the like in Step S100. When the control unit 300 has a function of generating the shaping data, the control unit 300 may acquire the shaping data by reading the generated shaping data by itself. The shaping data includes path data including multiple shaping paths representing the movement path of the nozzle tip for shaping, and material data for determining the type and the ejection amount of the material to be ejected in the shaping path.

In this embodiment, the shaping path designates the movement path of the nozzle tip for shaping by coordinate data that represent the start point and end point of the movement path. The material data of this embodiment designate the type of material in each shaping path and also designate the volume of the designated material to be ejected per unit movement amount, thereby determining the type and the ejection amount of the material to be ejected in the shaping path. More specifically, the material data of this embodiment designate the ejection portion 100 that ejects the material in each shaping path, thereby determining the type of material in the shaping path. Therefore, in this embodiment, the type of material held in the material holding portion 20 and the ejection portion 100 to which the material is supplied from the material holding portion 20 are linked to each other in advance. The control unit 300 can, for example, link the type of material to the ejection portion 100 based on the information of the type of material stored in the material holding portion 20 input through the unillustrated input portion or the like.

Further, the shaping data of this embodiment include purge data that designate the type and the ejection amount of the material to be ejected in a purging process. The purging process is a process for ejecting a predetermined amount of a predetermined type of material from the nozzle tip for shaping in order to purge the nozzle flow channel 61. The purge data are, for example, configured to execute the purging process for every predetermined number of shaping paths or for every predetermined amount of the material. The purge data of this embodiment designate the type of material to be ejected in the purging process and also designate the volume of the material as the amount of the material in the purging process in the same manner as the material data.

In Step S110, the control unit 300 performs material difference determination for determining whether or not the apparatus is in a material difference state. The material difference state is a state where the type of material associated with the nozzle tip for shaping and the type of material to be ejected from the nozzle tip for shaping are different.

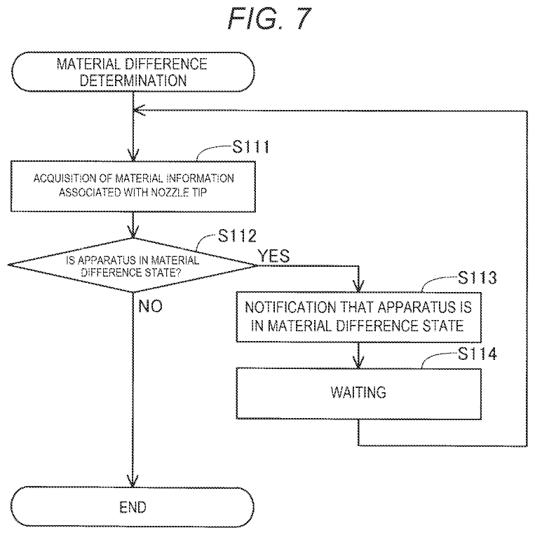

FIG. 7 is a process chart showing a material difference determination process. The control unit 300 executes the material difference determination process shown in FIG. 7 in Step S110 in FIG. 6. In Step S111, the control unit 300 acquires the material information associated with the nozzle tip for shaping. In this embodiment, the control unit 300 reads the material information recoded in the memory portion 66 of the nozzle tip 60 in Step S111.

In Step S112, the control unit 300 determines whether or not the apparatus is in the material difference state. In Step S112, the control unit 300 determines that the apparatus is in the material difference state when the type of material included in the material information read in Step S111 and the type of material included in the shaping data acquired in Step S100 in FIG. 6 are different. For example, when the shaping data include a shaping path in which the first ejection portion 100a performs ejection and a shaping path in which the second ejection portion 100b performs ejection, the control unit 300 determines whether or not the first material linked to the first ejection portion 100a and the type of material associated with the first nozzle tip 60a match with each other, and determines whether or not the second material linked to the second ejection portion 100b and the type of material associated with the second nozzle tip 60b match with each other. At that time, the control unit 300 determines that the apparatus is not in the material difference state when the types of materials match with each other in both of the determinations, and determines that the apparatus is in the material difference state when the types of materials do not match with each other in either one or both of the determinations. In a case where the material information is not recorded in the nozzle tip for shaping when Step S111 is executed, the control unit 300 excludes the nozzle tip for shaping from the subject of determination of the material difference state.

When it is determined that the apparatus is in the material difference state in Step S112, the control unit 300 notifies that the apparatus is in the material difference state through the notification portion 400 in Step S113. Subsequently, in Step S114, the control unit 300 makes the three-dimensional shaping apparatus 5 wait until the nozzle tip for shaping for which it is determined that the types of materials do not match with each other in the determination in Step S112 is replaced with another nozzle tip 60. In this embodiment, the control unit 300 notifies that the apparatus is in the material difference state by displaying a dialogue on the liquid crystal monitor constituting the notification portion 400, and also instructs a user to replace the nozzle tip 60 in Step S113. Further, the control unit 300 waits while displaying this dialogue on the liquid crystal monitor in Step S114. The user can eliminate the material difference state by, for example, replacing the nozzle tip 60 attached to the heating block 90 with another nozzle tip 60 while the three-dimensional shaping apparatus 5 is waiting based on the information that the apparatus is in the material difference state. The control unit 300 may, for example, end the material difference determination process when the nozzle tip 60 attached to the heating block 90 is not replaced even when a predetermined time has elapsed in Step S114.

The control unit 300 returns the process to Step S111 after Step S114 and acquires the material information associated with the nozzle tip 60 newly attached to the heating block 90 in the same manner. Thereafter, in Step S112, the control unit 300 determines whether or not the apparatus is in the material difference state in the same manner.

When it is determined that the apparatus is not in the material difference state in Step S112, the control unit 300 ends the material difference determination process and allows the process to proceed to Step S120 in FIG. 6. In Step S120, the control unit 300 performs shaping for one shaping path included in the shaping data based on the shaping data acquired in Step S100.

For example, when Step S120 is executed in a state where the material difference state is not eliminated, in Step S120, the material of a different type from the type of material associated with the nozzle tip for shaping is ejected from the nozzle tip for shaping. That is, in this case, the apparatus becomes in a state where the type of material first ejected from the nozzle tip for shaping and the type of material ejected later are different. In this state, for example, when the glass transition point of the former material is higher than the glass transition point of the latter material, when the latter material is ejected, the residue of the former material in the nozzle tip for shaping is not easily plasticized, and therefore, the residue of the former material becomes an impurity in the nozzle flow channel 61 to easily cause nozzle clogging. Further, when the glass transition point of the former material is lower than the glass transition point of the latter material, when the latter material is ejected, there is a possibility that the residue of the former material in the nozzle tip for shaping is carbonized to become an impurity, and nozzle clogging is easily caused. In this embodiment, the material difference state can be eliminated as described above, and therefore, such nozzle clogging can be suppressed.

In Step S130, the control unit 300 records the nozzle tip for shaping and the material information of the material ejected by the nozzle tip for shaping in Step S120 in association with each other. In this embodiment, the control unit 300 records the material information of the material ejected by the nozzle tip 60 in Step S120 in the memory portion 66 of the nozzle tip 60 in Step S130.

In a case where the material information is not recorded in the memory portion 66 when executing Step S130, the material information of the material ejected in a state where the nozzle tip for shaping is attached to the heating block 90 for the first time is newly recorded in the memory portion 66 in Step S130. Further, Step S130 is executed after the material difference determination in Step S110 described above, and therefore, when the material information is already recorded in the memory portion 66 when executing Step S130, material information similar to the material information already recorded in the memory portion 66 is overwritten in the memory portion 66 in Step S130. That is, in this embodiment, the control unit 300 records the nozzle tip for shaping and the material information of the material ejected in a state where the nozzle tip for shaping is attached to the heating block 90 for the first time in association with each other.

In other embodiments, the control unit 300 determines whether or not the nozzle tip for shaping has ejected the material for the first time in Step S120 prior to Step S130, and when it is determined that the nozzle tip has ejected the material for the first time, Step S130 is executed, and when it is determined that the nozzle tip has had the experience of ejecting the material before, Step S130 may be omitted. In this case, the control unit 300 determines that the nozzle tip for shaping has ejected the material for the first time when the material information is not recorded in the memory portion of the nozzle tip for shaping when executing this determination. Even in this case, the control unit 300 can record the nozzle tip for shaping and the material information of the material ejected after the nozzle tip for shaping is attached to the heating block 90 for the first time in association with each other. The control unit 300, for example, has recorded whether or not the material information is recorded in the memory portion 66 in Step S111 of the material difference determination shown in FIG. 7 in an unillustrated auxiliary memory device or the like of the control unit 300 in advance, and may perform the above-mentioned determination based thereon.

In Step S140, the control unit 300 updates the cumulative ejection amount of the nozzle tip for shaping. Note that in this embodiment, the cumulative ejection amount is represented as the volume of the material.

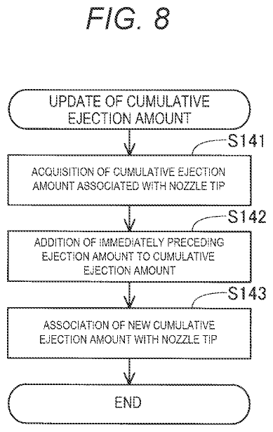

FIG. 8 is a process chart showing a cumulative ejection amount updating process in this embodiment. The control unit 300 executes the cumulative ejection amount updating process shown in FIG. 8 in Step S140 in FIG. 6. In Step S141, the control unit 300 acquires the cumulative ejection amount associated with the nozzle tip for shaping that has ejected the material immediately before. In this embodiment, in Step S141, the control unit 300 reads the cumulative ejection amount recorded in the memory portion 66 of the nozzle tip for shaping that has ejected the material in Step S120. For example, when the first nozzle tip 60a has ejected the first material in Step S120, the control unit 300 reads the cumulative ejection amount recorded in the first memory portion 66a of the first nozzle tip 60a in Step S141. Further, when the cumulative ejection amount is not recorded in the memory portion 66, that is, when the nozzle tip for shaping has never had the experience of ejecting the material before, the control unit 300 recognizes that the cumulative ejection amount of the nozzle tip for shaping is 0 in Step S141.

In Step S142, the control unit 300 newly calculates the cumulative ejection amount by adding the ejection amount of the material ejected from the nozzle tip for shaping immediately before to the cumulative ejection amount read in Step S141. The ejection amount of the material ejected from the nozzle tip for shaping may be calculated, for example, based on the shaping data or the actual measurement value. For example, when the stage 220 is provided with an unillustrated weight meter, the ejection amount of the material can be calculated based on the actual measurement value by measuring the weight of the ejected material with the weight meter, and calculating the volume of the material based on the measured weight and the density of the material.

In Step S143, the control unit 300 updates the cumulative ejection amount by associating the new cumulative ejection amount calculated in Step S142 and the nozzle tip for shaping again with each other. In this embodiment, in Step S143, the control unit 300 updates the cumulative ejection amount by writing back the new cumulative ejection amount calculated in Step S142 to the memory portion 66 of the nozzle tip for shaping whose cumulative ejection amount is read in Step S142.

In Step S150 in FIG. 6, the control unit 300 determines whether or not a purging process is performed. In this embodiment, the control unit 300 determines whether or not it is time to perform the purging process based on the above-mentioned purge data in Step S150. When it is determined that the purging process is not performed in Step S150, the control unit 300 allows the process to proceed to Step S190. When it is determined that the purging process is performed in Step S150, the control unit 300 performs the purging process in Step S160. In this embodiment, the control unit 300 ejects the material having a volume designated by the purge data from the nozzle tip for shaping in Step S160.

In Step S170, the control unit 300 records the nozzle tip for shaping and the material information of the material ejected by the nozzle tip for shaping in Step S160 in association with each other in the same manner as in Step S130. In this embodiment, the control unit 300 records the material information of the material ejected by the nozzle tip 60 in Step S160 in the memory portion 66 of the nozzle tip 60 in Step S170.

In Step S180, the control unit 300 updates the cumulative ejection amount by executing the cumulative ejection amount updating process shown in FIG. 8 in the same manner as in Step S140. In the cumulative ejection amount updating process executed in Step S180, the control unit 300 calculates a new cumulative ejection amount by adding the ejection amount of the material ejected in the purging process in Step S160 to the cumulative ejection amount read in Step S141 in Step S142 in FIG. 8.

In Step S190, the control unit 300 determines whether or not the three-dimensional shaped article is completed. In this embodiment, the control unit 300 determines that the three-dimensional shaped article is completed when shaping is performed for all the shaping paths included in the shaping data in Step S190. When it is determined that the three-dimensional shaped article is completed in Step S190, the control unit 300 ends the three-dimensional shaping process. When it is determined that the three-dimensional shaped article is not completed in Step S190, the control unit 300 returns the process to Step S120, and performs shaping for the subsequent one shaping path. In this manner, the control unit 300 completes the three-dimensional shaped article by repeatedly executing the process from Step S120 to Step S190 until shaping is performed for all the shaping paths.

According to the three-dimensional shaping apparatus 5 of this embodiment described above, the nozzle tip 60 has the shield 68 for suppressing heat transfer to the stacked material from the heating block 90, and the control unit 300 records the nozzle tip for shaping and the material information regarding the type of material in association with each other. Therefore, by the shield 68, heat transfer to the stacked material from the heating block 90 is suppressed so as to suppress deformation of the three-dimensional shaped article. Further, the possibility that one nozzle tip 60 ejects multiple materials can be reduced based on the material information associated with the nozzle tip for shaping, and therefore, clogging of the nozzle tip 60 can be suppressed.

Further, in this embodiment, the control unit 300 records the nozzle tip for shaping and the material information of the material ejected in a state where the nozzle tip for shaping is attached to the heating block 90 for the first time in association with each other. Therefore, the possibility that the nozzle tip 60 ejects a material other than the material ejected for the first time can be reduced, and clogging of the nozzle tip 60 can be suppressed.

Further, in this embodiment, the control unit 300 records the nozzle tip for shaping and the cumulative ejection amount of the material ejected after the nozzle tip for shaping is attached to the heating block 90 for the first time in association with each other. According to this, not only the material information associated with the nozzle tip for shaping, but also the cumulative ejection amount of the material can be obtained. Therefore, for example, by replacing the nozzle tip for shaping in advance according to the cumulative ejection amount of the material, nozzle clogging during shaping of the three-dimensional shaped article can be suppressed.

Further, in this embodiment, when the apparatus is in the material difference state, the control unit 300 controls the notification portion 400 to notify that the apparatus is in the material difference state. Therefore, for example, by replacing the nozzle tip for shaping with another nozzle tip 60 based on the information notified by the notification portion 400, the material difference state can be eliminated, and the possibility that one nozzle tip 60 ejects multiple materials can be further reduced.

Further, in this embodiment, the nozzle tip 60 has the memory portion 66, and the control unit 300 records the material information in the memory portion 66. Therefore, by recording the material information in the memory portion 66 of the nozzle tip for shaping, the nozzle tip for shaping and the material information can be associated with each other.

Further, in this embodiment, the memory portion 66 is located between the nozzle opening 63 and the shield 68 in the Z direction. Therefore, in the attached state, heat transfer to the memory portion 66 from the heating block 90 is suppressed by the shield 68.

### B. Second Embodiment

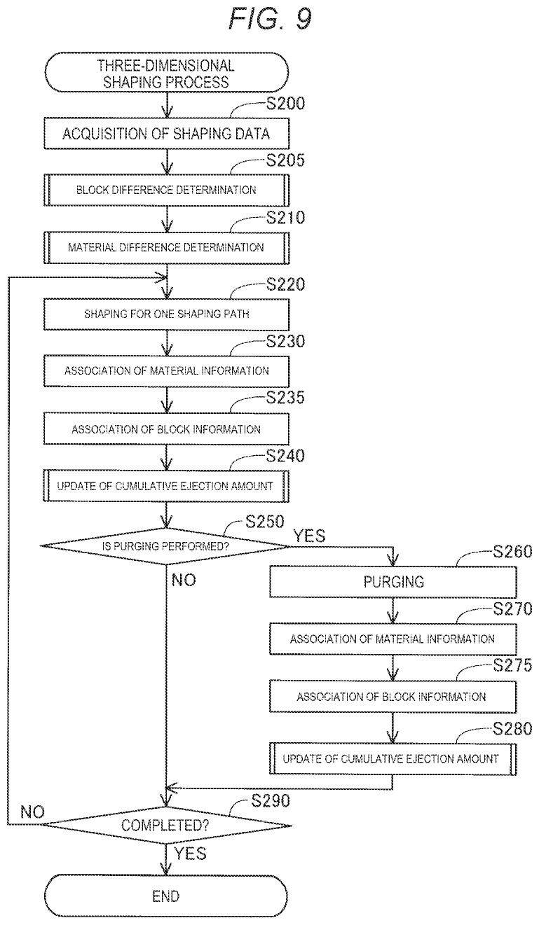

FIG. 9 is a process chart showing a three-dimensional shaping process in a second embodiment. In this embodiment, the control unit 300 performs block difference determination for determining whether or not the apparatus is in a block difference state in addition to the material difference determination unlike the first embodiment in the three-dimensional shaping process. The block difference state is a state where the nozzle tip 60 is attached to the heating block 90 other than the heating block 90 associated with the nozzle tip 60. Portions that are not particularly described in the configuration of the three-dimensional shaping apparatus 5 of this embodiment are the same as those of the first embodiment.

In the memory portion 66 of the nozzle tip 60 of this embodiment, block information is recorded in addition to the material information and the cumulative ejection amount by the control unit 300. The block information refers to information regarding information for identifying the heating block 90, and is, for example, the individual identification number of the heating block 90. Further, in other embodiments, for example, when the nozzle tip 60 has a memory portion different from the memory portion 66, the block information may be recorded in the memory portion different from the memory portion 66. That is, the memory portion in which the material information is recorded and the memory portion in which the block information is recorded may be separate bodies.

Step S200 in FIG. 9 is the same as Step S100 in FIG. 6, and therefore, the description thereof will be omitted. In Step S205 in FIG. 9, the control unit 300 performs the block difference determination.

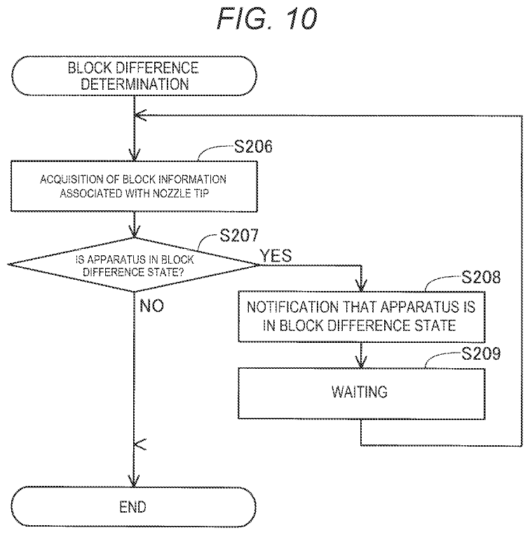

FIG. 10 is a process chart showing a block difference determination process. The control unit 300 executes the block difference determination process shown in FIG. 10 in Step S205 in FIG. 9. In Step S206, the control unit 300 acquires the block information associated with the nozzle tip for shaping. In this embodiment, the control unit 300 reads the block information recorded in the memory portion 66 of the nozzle tip 60 in Step S206.

In Step S207, the control unit 300 determines whether or not the apparatus is in the block difference state. In Step S207, the control unit 300 determines that the apparatus is in the block difference state when the block information read in Step S206 and the block information of the heating block 90 to which the nozzle tip 60 is attached are different. More specifically, in Step S207 of this embodiment, the control unit 300 determines whether or not the block information recorded in the first memory portion 66a of the first nozzle tip 60a attached to the first heating block 90a and the block information of the first heating block 90a match with each other, and determines whether or not the block information recorded in the second memory portion 66b of the second nozzle tip 60b attached to the second heating block 90b and the block information of the second heating block 90b match with each other. At that time, the control unit 300 determines that the apparatus is not in the block difference state when the block information matches in both of the determinations, and determines that the apparatus is in the block difference state when the block information does not match in either one or both of the determinations. In a case where the block information is not recorded in the memory portion 66 of the nozzle tip 60 when Step S206 is executed, the control unit 300 excludes the nozzle tip for shaping from the subject of determination of the block difference state.

When it is determined that the apparatus is in the block difference state in Step S207, in Step S208, the control unit 300 notifies that the apparatus is in the block difference state through the notification portion 400, for example, in the same manner as in Step S113 in FIG. 7. Subsequently, in Step S209, the control unit 300 makes the three-dimensional shaping apparatus 5 wait in the same manner as in Step S114 in FIG. 7 until the nozzle tip 60 for which it is determined that the block information does not match in the determination in Step S207 is replaced with another nozzle tip 60. According to this, a user can eliminate the block difference state by replacing the attached nozzle tip 60 with another nozzle tip 60 while the three-dimensional shaping apparatus 5 is waiting.

The control unit 300 returns the process to Step S206 after Step S209 and acquires the block information associated with the nozzle tip 60 newly attached to the heating block 90 in the same manner. Thereafter, in Step S207, the control unit 300 determines whether or not the apparatus is in the block difference state in the same manner. When it is determined that the apparatus is not in the block difference state in Step S207, the control unit 300 ends the block difference state determination process and allows the process to proceed to Step S210 in FIG. 9. Step S210 to Step S230 are the same as Step S110 to Step S130 in FIG. 6, and therefore, the description thereof will be omitted.

For example, when Step S220 is executed in a state where the block difference state is not eliminated, the nozzle tip for shaping ejects the material in a state where it is attached to the heating block 90 different from the heating block 90 associated with the nozzle tip for shaping in Step S220. Here, for example, when the nozzle tip 60 is first attached to the first heating block 90a for plasticizing the shaping material and thereafter attached to the second heating block 90b for plasticizing the support material, even if the first material and the second material are of the same type, there is a possibility that the materials plasticized under different temperature conditions exist in a mixed state in the nozzle tip 60, and nozzle clogging is easily caused. In this embodiment, the block difference state can be eliminated as described above, and therefore, such nozzle clogging can be suppressed.

In Step S235 in FIG. 9, the control unit 300 records the nozzle tip 60 attached to the heating block 90 and the block information of the heating block 90 to which the nozzle tip 60 is attached in association with each other. In this embodiment, in Step S235, the control unit 300 records identification information of the heating block 90 to which the nozzle tip 60 is attached in the memory portion 66 of the nozzle tip 60 that has ejected the material in Step S220. Therefore, in this embodiment, when the material is ejected in a state where the nozzle tip 60 is attached to the heating block 90 for the first time, the nozzle tip 60 and the block information of the heating block 90 are recorded in association with each other. In other embodiments, the control unit 300 may determine whether or not the nozzle tip 60 is attached to the heating block 90 for the first time prior to Step S235. Further, when the control unit 300 determines, prior to Step S230, whether or not the nozzle tip 60 has ejected the material for the first time in Step S220, when it is determined that the nozzle tip has ejected the material for the first time, Step S235 is executed, and when it is determined that the nozzle tip has had the experience of ejecting the material before, Step S235 may be omitted in the same manner as Step S230 is omitted.

Step S240 to Step S270 are the same as Step S140 to Step S170 in FIG. 6, and therefore, the description thereof will be omitted. In Step S275 in FIG. 9, the control unit 300 records the nozzle tip 60 that has ejected the material in Step S260 and the block information in association with each other in the same manner as in Step S235. Step S280 and Step S290 are the same as Step S180 and Step S190 in FIG. 6, and therefore, the description thereof will be omitted.

According also to the three-dimensional shaping apparatus 5 of this embodiment described above, heat transfer to the stacked material from the heating block 90 is suppressed by the shield 68 so as to suppress deformation of the three-dimensional shaped article. Further, the possibility that one nozzle tip 60 ejects multiple materials can be reduced based on the material information associated with the nozzle tip for shaping, and therefore, clogging of the nozzle tip 60 can be suppressed. In particular, in this embodiment, the control unit 300 records the nozzle tip 60 attached to the heating block 90 and the block information of the heating block 90 to which the nozzle tip 60 is attached in association with each other. Due to this, the possibility that one nozzle tip 60 is attached to multiple heating blocks 90 can be reduced, and therefore, clogging of the nozzle tip 60 can be further suppressed.

### C. Third Embodiment

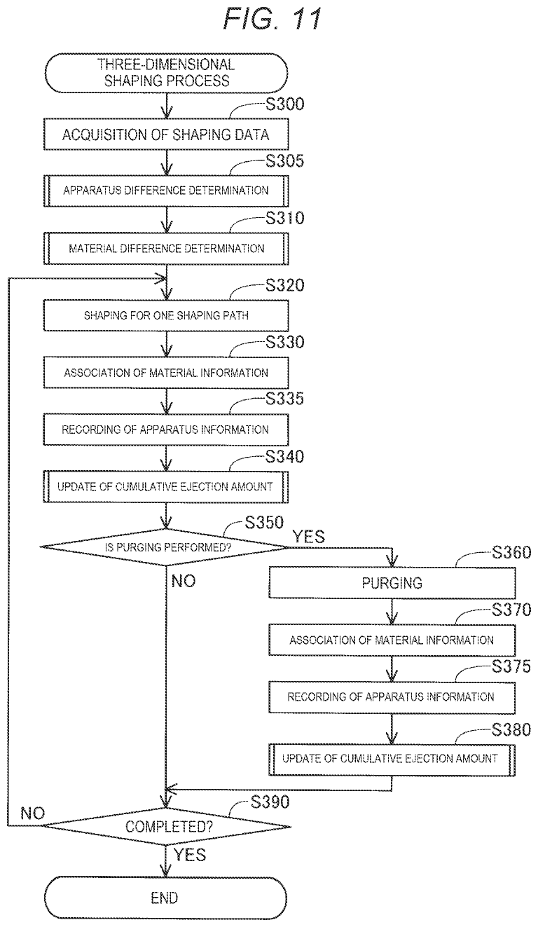

FIG. 11 is a process chart showing a three-dimensional shaping process in a third embodiment. In this embodiment, the control unit 300 performs apparatus difference determination for determining whether or not the apparatus is in an apparatus difference state in addition to the material difference determination unlike the first embodiment in the three-dimensional shaping process. The apparatus difference state is a state where the nozzle tip 60 is attached to the three-dimensional shaping apparatus 5 other than the three-dimensional shaping apparatus 5 associated with the nozzle tip 60. The state where the nozzle tip 60 is attached to the three-dimensional shaping apparatus 5 refers to a state where the nozzle tip 60 is attached to the heating block 90 provided in the three-dimensional shaping apparatus 5. For example, in this embodiment, when the nozzle tip 60 is attached to the first heating block 90a or the second heating block 90b, it means that the nozzle tip 60 is attached to the three-dimensional shaping apparatus 5. Further, portions that are not particularly described in the configuration of the three-dimensional shaping apparatus 5 of this embodiment are the same as those of the first embodiment.

In the memory portion 66 of the nozzle tip 60 of this embodiment, apparatus information is recorded in addition to the material information and the cumulative ejection amount by the control unit 300. The apparatus information refers to information regarding information for identifying the three-dimensional shaping apparatus 5, and is, for example, the individual identification number of the three-dimensional shaping apparatus 5. In other embodiments, for example, when the nozzle tip 60 has a memory portion different from the memory portion 66, the apparatus information may be recorded in the memory portion different from the memory portion 66. That is, the memory portion in which the material information is recorded and the memory portion in which the apparatus information is recorded may be separate bodies.

Step S300 in FIG. 11 is the same as Step S100 in FIG. 6, and therefore, the description thereof will be omitted. In Step S305 in FIG. 11, the control unit 300 performs the apparatus difference determination.

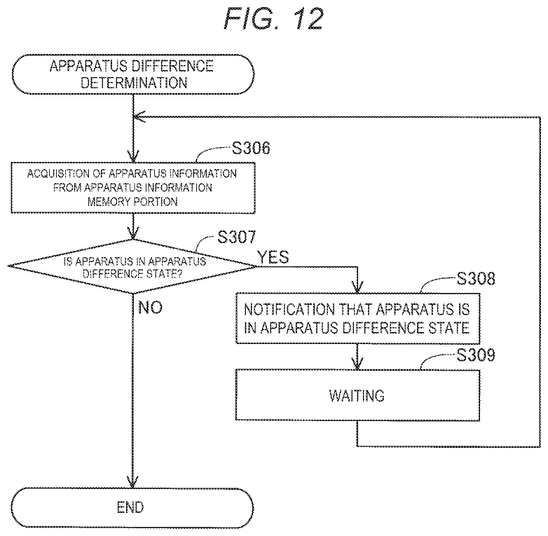

FIG. 12 is a process chart showing an apparatus difference determination process. The control unit 300 executes the apparatus difference determination process shown in FIG. 12 in Step S305 in FIG. 11. In Step S306, the control unit 300 acquires the apparatus information recorded in the memory portion 66 of the nozzle tip for shaping. In this embodiment, the control unit 300 reads the apparatus information recorded in the memory portion 66 of the nozzle tip 60 in Step S306.

In Step S307, the control unit 300 determines whether or not the apparatus is in the apparatus difference state. In Step S307, the control unit 300 determines that the apparatus is in the apparatus difference state when the apparatus information read in Step S306 and the apparatus information of the three-dimensional shaping apparatus 5 to which the nozzle tip 60 is attached are different. More specifically, in Step S307 of this embodiment, the control unit 300 determines whether or not the apparatus information recorded in the first memory portion 66a of the first nozzle tip 60a attached to the first heating block 90a and the apparatus information recorded in the second memory portion 66b of the second nozzle tip 60b attached to the second heating block 90b match with the apparatus information of the three-dimensional shaping apparatus 5, and determines that the apparatus is not in the apparatus difference state when both match. When it is determined that the apparatus is not in the apparatus difference state in Step S307, the control unit 300 ends the apparatus difference state determination process and allows the process to proceed to Step S310 shown in FIG. 11. In a case where the apparatus information is not recorded in the nozzle tip 60 when Step S306 is executed, the control unit 300 excludes the nozzle tip 60 from the subject of the apparatus difference state determination process.

When it is determined that the apparatus is in the apparatus difference state in Step S307, in Step S308, the control unit 300 notifies that the apparatus is in the apparatus difference state through the notification portion 400, for example, in the same manner as in Step S113 in FIG. 7. Subsequently, in Step S309, the control unit 300 makes the three-dimensional shaping apparatus 5 wait in the same manner as in Step S114 in FIG. 7 until the nozzle tip 60 for which it is determined that the apparatus information does not match in the determination in Step S307 is replaced with another nozzle tip 60. According to this, a user can eliminate the apparatus difference state by replacing the attached nozzle tip 60 with another nozzle tip 60 while the three-dimensional shaping apparatus 5 is waiting.

The control unit 300 returns the process to Step S306 after Step S309 and acquires the apparatus information associated with the nozzle tip 60 newly attached to the heating block 90 in the same manner. Thereafter, in Step S307, the control unit 300 determines whether or not the apparatus is in the apparatus difference state in the same manner. When it is determined that the apparatus is not in the apparatus difference state in Step S307, the control unit 300 ends the apparatus difference state determination process and allows the process to proceed to Step S310 in FIG. 11. Step S310 to Step S330 are the same as Step S110 to Step S130 in FIG. 6, and therefore, the description thereof will be omitted.

In Step S335 in FIG. 11, the control unit 300 records the apparatus information in the memory portion 66 of the nozzle tip for shaping. In this embodiment, in Step S335, the control unit 300 records the apparatus information in the memory portion 66 of the nozzle tip 60 that has ejected the material in Step S320. In other embodiments, the control unit 300 may determine whether or not the nozzle tip 60 is attached to the three-dimensional shaping apparatus 5 for the first time prior to Step S335. Further, when the control unit 300 determines, prior to Step S330, whether or not the nozzle tip 60 has ejected the material for the first time in Step S320, when it is determined that the nozzle tip has ejected the material for the first time, Step S335 is executed, and when it is determined that the nozzle tip has had the experience of ejecting the material before, Step S335 may be omitted in the same manner as Step S330 is omitted.

Step S340 to Step S370 are the same as Step S140 to Step S170 in FIG. 6, and therefore, the description thereof will be omitted. In Step S375, the control unit 300 records the apparatus information in the memory portion 66 of the nozzle tip 60 that has ejected the material in Step S360 in the same manner as in Step S335. Step S380 and Step S390 are the same as Step S180 and Step S190 in FIG. 6, and therefore, the description thereof will be omitted.

According also to the three-dimensional shaping apparatus 5 of this embodiment described above, heat transfer to the stacked material from the heating block 90 is suppressed by the shield 68 so as to suppress deformation of the three-dimensional shaped article. Further, the possibility that one nozzle tip 60 ejects multiple materials can be reduced based on the material information associated with the nozzle tip for shaping, and therefore, clogging of the nozzle tip 60 can be suppressed. In particular, in this embodiment, the control unit 300 records the apparatus information in the memory portion 66 of the nozzle tip for shaping. Due to this, the possibility that one nozzle tip 60 is attached to multiple three-dimensional shaping apparatuses 5 can be reduced, and therefore, the nozzle tip 60 is less likely to be affected by differences in temperature conditions or the like among apparatuses or individual differences among apparatuses or the like, and clogging of the nozzle tip 60 can be further suppressed.

### D. Fourth Embodiment

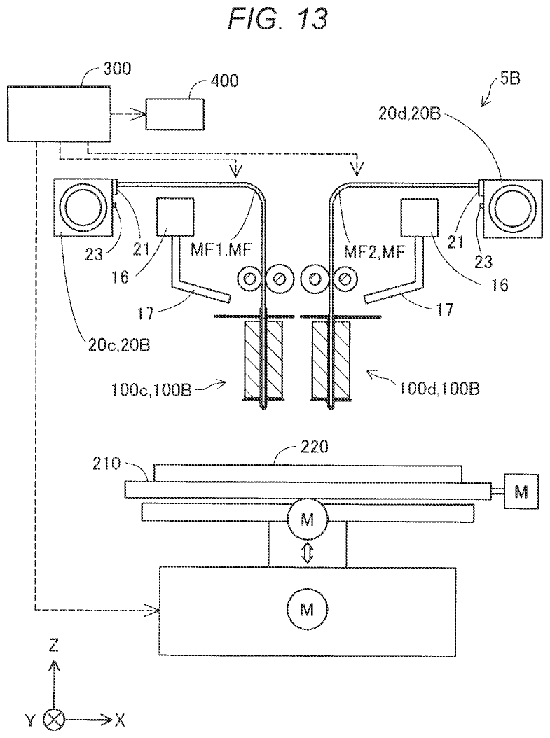

FIG. 13 is a view showing a schematic configuration of a three-dimensional shaping apparatus 5B according to a fourth embodiment. The three-dimensional shaping apparatus 5B of this embodiment is a three-dimensional shaping apparatus using the ME method in the same manner as in the first embodiment, but the configurations of the respective portions are different from those of the first embodiment. The description of the same configuration as that of the first embodiment in the configuration of the three-dimensional shaping apparatus 5B of this embodiment will be omitted.

The three-dimensional shaping apparatus 5B of this embodiment includes two ejection portions 100B, two material holding portions 20B, the moving mechanism portion 210, the stage 220, the control unit 300, and the notification portion 400 in the same manner as that of the first embodiment. The three-dimensional shaping apparatus 5B specifically includes a first ejection portion 100c and a second ejection portion 100d as the ejection portions 100B, and includes a first material holding portion 20c and a second material holding portion 20d as the material holding portions 20B. Hereinafter, when the first ejection portion 100c and the second ejection portion 100d are described without particularly making a distinction between them, these portions are sometimes simply referred to as “ejection portion 100B”. Similarly, when the first material holding portion 20c and the second material holding portion 20d are described without particularly making a distinction between them, these portions are sometimes simply referred to as “material holding portion 20B”. Further, when a constituent element related to the first ejection portion 100c and a constituent element related to the second ejection portion 100d are described while making a distinction between them, for the constituent element related to the first ejection portion 100c, “c” is attached to the end of the reference numeral, and for the constituent element related to the second ejection portion 100d, “d” is attached to the end of the reference numeral.

The three-dimensional shaping apparatus 5B further includes two blowers 16. The blower 16 is constituted as an air blowing machine that blows air to the ejection portion 100B through a manifold 17.

The material holding portion 20B of this embodiment is constituted as a holder that stores a filamentous material MF. The material holding portion 20B includes an outlet portion 21 and an unwinding amount memory portion 23. The material holding portion 20B is configured to be able to unwind the material MF stored therein to the outside of the material holding portion 20B through the outlet portion 21. In this embodiment, in the first material holding portion 20c, the shaping material is stored as a first material MF1, and in the second material holding portion 20d, the soluble support material is stored as a second material MF2.

The unwinding amount memory portion 23 is constituted by an IC chip as a memory medium and is coupled to the control unit 300 through an unillustrated wiring and an unillustrated coupling portion. In the unwinding amount memory portion 23, the type of material in the material holding portion 20B and the amount of the material MF unwound to the outside from the material holding portion 20B are recorded by the control unit 300. In this embodiment, the control unit 300 links the type of the material MF to the ejection portion 100B based on the information of the type of the material MF recorded in the unwinding amount memory portion 23.

In the unwinding amount memory portion 23, the amount of the material MF unwound from the material holding portion 20B is recorded as a volume calculated by multiplying a wire diameter of the material MF by the length of the unwound material MF. In this case, the length of the unwound material MF may be calculated, for example, based on the rotational speed of an unillustrated feeding roller provided in the material holding portion 20B or based on the feeding amount of the material MF by the below-mentioned material conveying mechanism 40B. In addition, in the unwinding amount memory portion 23, for example, the residual amount of the material MF may be recorded. The residual amount of the material MF is, for example, calculated by the control unit 300 based on the initial filling amount of the material MF stored in the material holding portion 20B and the amount of the material MF unwound from the material holding portion 20B.

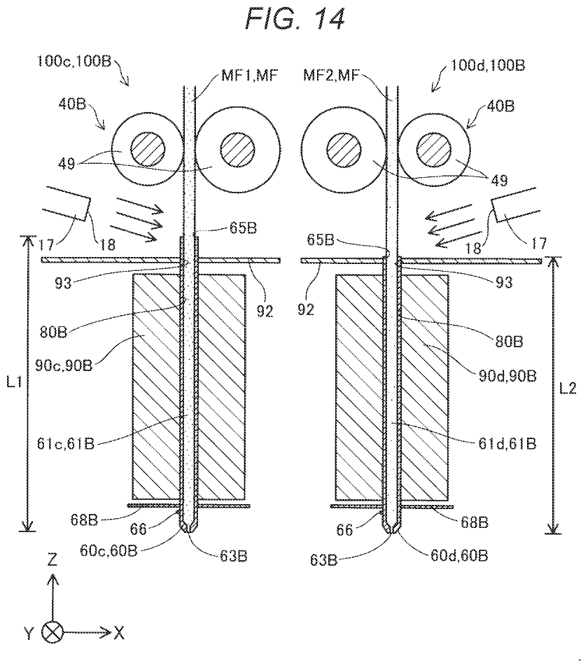

FIG. 14 is a view for illustrating a schematic configuration of the ejection portion 1003 of this embodiment. The ejection portion 100B includes a heating block 90B that has a heater and is provided with a through hole 80B, a nozzle tip 60B that is detachably attached to the through hole 80B, and a material conveying mechanism 40B that conveys a material to a nozzle flow channel 61B of a nozzle tip for shaping being the nozzle tip 60B attached to the heating block 90B in the same manner as in the first embodiment. In addition, the ejection portion 100B further includes a heat shield 92 that is disposed between the material conveying mechanism 40B and the heating block 90B in the Z direction and suppresses heat transfer to the material conveying mechanism 40B from the heating block 90B. The material conveying mechanism 40B of this embodiment is constituted by two wheels 49 without including the screw case 31 or the screw 41 unlike the first embodiment. The heating block 90B does not include the barrel 50 or the case portion 91 unlike the first embodiment.

The nozzle tip 60B of this embodiment is attached to the heating block 90B by being inserted into the through hole 80B and a shield opening 93 provided in the heat shield 92 from the −Z direction unlike the first embodiment. That is, in this embodiment, the dimension along the Z direction of the nozzle tip 60B and the dimension along the Z direction of the nozzle flow channel 61B are longer than the dimension along the Z direction of the through hole 80B. Therefore, in this embodiment, a flow inlet 65B provided at the rear end of the nozzle tip 60B is located in the +Z direction of the heating block 90B, more specifically, in the +Z direction of the heat shield 92. In this embodiment, the first nozzle tip 60c to be attached to the first heating block 90c is a main tip in the same manner as in the first embodiment. The second nozzle tip 60d to be attached to the second heating block 90d is a tip for a soluble support that ejects a soluble support material unlike the first embodiment. That is, the nozzle tip 603 of this embodiment is the main tip or the tip for a soluble support.

The nozzle tip 60B includes a shield 68B in the same manner as in the first embodiment. The nozzle tip 60B includes the memory portion 66 in the same manner as in the first embodiment. In the memory portion 66, the material information and the cumulative ejection amount are recorded by the control unit 300 in the same manner as in the first embodiment. The memory portion 66 is located between the nozzle opening 63B and the shield 68B in the Z direction in the same manner as in the first embodiment.

The two wheels 49 constituting the material conveying mechanism 40B draw out the material MF in the material holding portion 20B by their rotation to guide the material between the two wheels 49, and convey the material to the nozzle flow channel 61B of the nozzle tip 60B attached to the through hole 80B of the heating block 90B. The heating block 90B plasticizes the material MF conveyed into the nozzle flow channel 61B of the nozzle tip 60B by heat of an unillustrated heater incorporated in the heating block 90B.

The material MF of this embodiment is cooled by air sent from the blower 16 through the manifold 17 in the vicinity of the flow inlet 65B of the nozzle tip 60B. By doing this, plasticization of the material MF in the vicinity of the flow inlet 65B is suppressed, and the material MF is efficiently conveyed into the flow inlet 65B. An outlet end 18 of the manifold 17 is located in the +Z direction of the heat shield 92. Due to this, air sent out from the manifold 17 is easily guided to the vicinity of the flow inlet 65B by the heat shield 92, and therefore, the material MF in the vicinity of the flow inlet 65B is efficiently cooled.

As shown in FIG. 14, a length L2 of a second nozzle flow channel 61d of the second nozzle tip 60d that is the tip for a soluble support is shorter than a length L1 of a first nozzle flow channel 61c of the first nozzle tip 60c that is the main tip. The soluble support material is generally more easily plasticized than the shaping material. Therefore, since the length L2 is shorter than the length L1, deterioration of the soluble support material in the tip for a soluble support is suppressed, and deposition of the material due to use over time is suppressed. Further, the shaping material is generally less easily plasticized than the soluble support material. Therefore, since the length L1 is longer than the length L2, plasticization of the shaping material in the main tip is accelerated.

Also in this embodiment, the control unit 300 can shape a three-dimensional shaped article by, for example, executing the three-dimensional shaping process shown in FIG. 6 in the same manner as in the first embodiment.

According also to the three-dimensional shaping apparatus 5B of this embodiment described above, heat transfer to the stacked material from the heating block 90B is suppressed by the shield 68B so as to suppress deformation of the three-dimensional shaped article. Further, the possibility that one nozzle tip 60B ejects multiple materials can be reduced based on the material information associated with the nozzle tip for shaping, and therefore, clogging of the nozzle tip 60B can be suppressed. In particular, in this embodiment, the nozzle tip 60B is the main tip or the tip for a soluble support. Therefore, when the nozzle tip 60B is the main tip, the three-dimensional shaped article can be shaped by ejecting the shaping material from the nozzle tip 60B. Further, when the nozzle tip 60B is the tip for a soluble support, the shape of the shaped article in the middle of shaping can be held by ejecting the soluble support material from the nozzle tip 60B.

Further, in this embodiment, the nozzle flow channel of the tip for a soluble support is shorter than the nozzle flow channel of the main tip. Therefore, when the nozzle tip 60B is the tip for a soluble support, deposition of the material in the nozzle flow channel 61B is suppressed, and nozzle clogging in the nozzle tip 60B is suppressed. Further, when the nozzle tip 60B is the main tip, plasticization of the shaping material in the nozzle flow channel 61B is accelerated.

In other embodiments, in the memory portion 66, for example, block information may be recorded in the same manner as in the second embodiment, or apparatus information may be recorded in the same manner as in the third embodiment. In this case, the control unit 300 can execute the three-dimensional shaping process shown in FIG. 9 or the three-dimensional shaping process shown in FIG. 11 in the same manner as in the second embodiment or the third embodiment.

### E. Fifth Embodiment

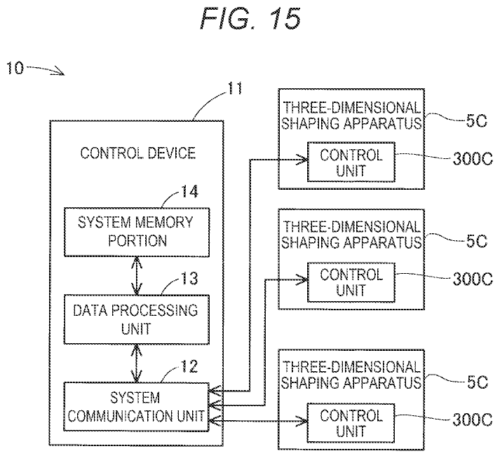

FIG. 15 is a schematic block diagram showing a configuration of a three-dimensional shaping system 10 as a fifth embodiment. The three-dimensional shaping system 10 includes a three-dimensional shaping apparatus 5C and a control device 11. The three-dimensional shaping system 10 of this embodiment includes three three-dimensional shaping apparatuses 5C. In other embodiments, the number of three-dimensional shaping apparatuses 5C in the three-dimensional shaping system 10 may be 1 or 2 or may be 4 or more. Further, portions that are not particularly described in the three-dimensional shaping apparatus 5C of this embodiment are the same as those of the first embodiment. In other embodiments, the three-dimensional shaping apparatus 5C may be, for example, configured to plasticize a filamentous material MF and eject the plasticized material in the same manner as in the fourth embodiment.

The control device 11 is constituted by a computer including one or more processors, a main memory device, and an input/output interface for performing signal input/output to/from the outside. The control device 11 exhibits various functions by executing a program or a command read in the main memory device by the processor. The control device 11 may be constituted by a combination of multiple circuits instead of a computer.

In the three-dimensional shaping apparatus 5C of this embodiment, the control unit 300C does not record the nozzle tip for shaping and the material information regarding the type of material in association with each other unlike the first embodiment. Further, in this embodiment, in the memory portion 66 of the nozzle tip 60, the material information and the cumulative ejection amount are not recorded. On the other hand, in the memory portion 66 of this embodiment, nozzle information is stored. The nozzle information is information regarding information for identifying the nozzle tip 60, and is, for example, the individual identification number of the nozzle tip 60. Further, the three-dimensional shaping apparatus 5C includes a communication unit configured to be able to communicate with the control device 11 by wire or wirelessly. The communication unit transmits the nozzle information of the nozzle tip for shaping and the material information to the control device 11. In this embodiment, the control unit 300C functions as the communication unit. Further, in this embodiment, the control unit 300C that functions as the communication unit transmits the cumulative ejection amount in addition to the nozzle information and the material information to the control device 11.

The control device 11 includes a system communication unit 12, a data processing unit 13, and a system memory portion 14. The system communication unit 12 communicates with the control unit 300C that functions as the communication unit and receives the nozzle information, the material information, and the ejection amount information transmitted from the control unit 300C. The data processing unit 13 associates the nozzle information with the material information, and also associates the nozzle information with the cumulative ejection amount, and records them in the system memory portion 14.

Further, the control unit 300C of this embodiment can acquire information associated with the nozzle information recorded in the system memory portion 14 by communicating with the control device 11. In this case, the control unit 300C, for example, transmits the nozzle information of the nozzle tip 60 whose information is desired to be acquired to the control device 11. The control device 11 acquires the information associated with the nozzle information recorded in the system memory portion 14 by the data processing unit 13 based on the nozzle information received by the system communication unit 12, and transmits the information to the control unit 300C by the system communication unit 12.

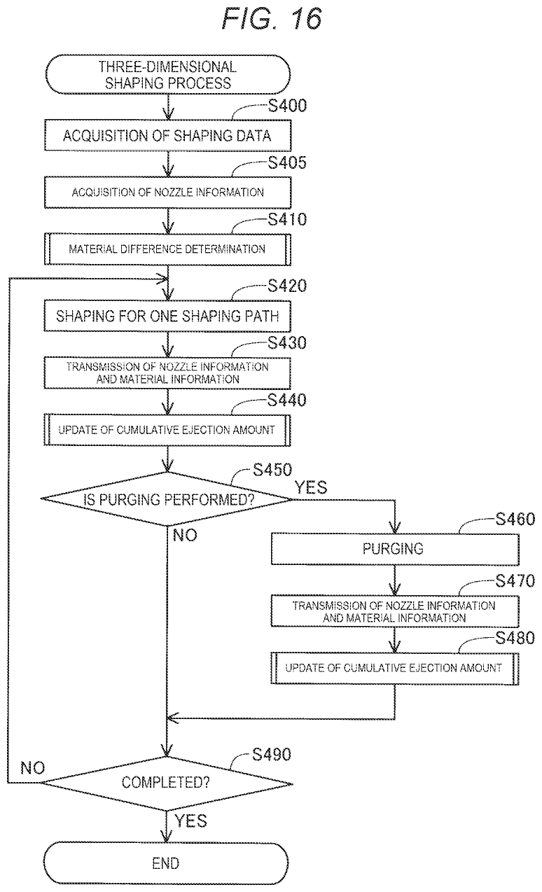

FIG. 16 is a process chart showing an example of a three-dimensional shaping process in this embodiment. The three-dimensional shaping process shown in FIG. 16 is, for example, executed by the control unit 300C that has received a start command in the same manner as in the first embodiment.

Step S400 is the same as Step S100 shown in FIG. 6, and therefore, the description thereof will be omitted. In Step S405, the control unit 300C acquires the nozzle information by reading the nozzle information from the memory portion 66 of the nozzle tip for shaping.

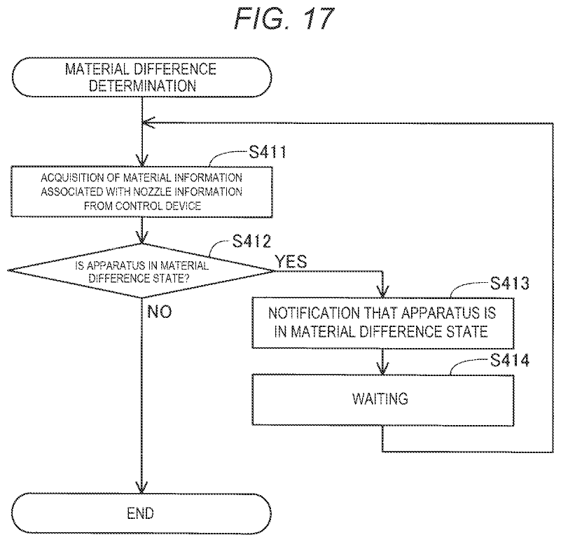

FIG. 17 is a process chart showing material difference determination in this embodiment. In Step S410 in FIG. 16, the control unit 300C executes the material difference determination shown in FIG. 17. In Step S411 in FIG. 17, the control unit 300C acquires the material information associated with the nozzle information acquired in Step S405 in FIG. 16 from the control device 11 by communicating with the control device 11. Specifically, the control unit 300C transmits the nozzle information acquired in Step S405 in FIG. 16 to the control device 11 and acquires the material information recorded in the system memory portion 14 associated with the nozzle information that matches with the transmitted nozzle information in Step S411. Step S412 to Step S414 are the same as Step S112 to Step S114 in FIG. 7, and therefore, the description thereof will be omitted.

Step S420 in FIG. 16 is the same as Step S120 in FIG. 6, and therefore, the description thereof will be omitted. In Step S430, the control unit 300C transmits the nozzle information of the nozzle tip 60 that has ejected the material in Step S420 and the material information of the material ejected from the nozzle tip 60 in Step S420 to the control device 11. The control device 11 records the material information and the nozzle information transmitted from the control unit 300C in association with each other in the system memory portion 14. In other embodiments, the control unit 300C determines, prior to Step S430, whether or not the nozzle tip for shaping has ejected the material for the first time in Step S420, and when it is determined that the nozzle tip has had the experience of ejecting the material before, Step S430 may be omitted.

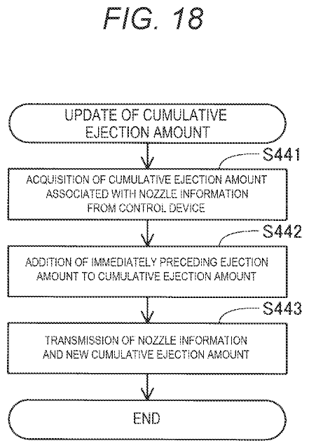

FIG. 18 is a process chart showing a cumulative ejection amount updating process in this embodiment. In Step S440 in FIG. 16, the control unit 300C executes the cumulative ejection amount updating process shown in FIG. 18. In Step S441 in FIG. 18, the control unit 300C acquires the cumulative ejection amount associated with the nozzle tip for shaping that has ejected the material immediately before from the control device 11 by communicating with the control device 11. Specifically, the control unit 300C acquires the nozzle information of the nozzle tip 60 that has ejected the material in Step S420 in FIG. 16, and transmits the acquired nozzle information to the control device 11, and then, acquires the cumulative ejection amount recorded in the system memory portion 14 associated with the nozzle information that matches with the transmitted nozzle information in Step S441. Step S442 is the same as Step S142 in FIG. 8, and therefore, the description thereof will be omitted. In Step S443, the control unit 300C transmits the nozzle information acquired in Step S441 and a new cumulative ejection amount calculated in Step S442 to the control device 11. The control device 11 records the transmitted nozzle information and new cumulative ejection amount in association with each other in the system memory portion 14. In other embodiments, for example, the control device 11 may update the cumulative ejection amount based on the nozzle information and the ejection amount transmitted from the control unit 300C. In this case, the data processing unit 13 of the control device 11, for example, reads the cumulative ejection amount recorded in the system memory portion 14 based on the nozzle information received from the control unit 300C by the system communication unit 12, and calculates a new cumulative ejection amount by adding the ejection amount received from the control unit 300C to the read cumulative ejection amount, and then, records the new cumulative ejection amount in the system memory portion 14.

Step S450 and Step S460 in FIG. 16 are the same as Step S150 and Step S160 in FIG. 6, and therefore, the description thereof will be omitted. In Step S470 in FIG. 16, the control unit 300C transmits the nozzle information of the nozzle tip for shaping that has ejected the material in Step S460 and the material information of the material ejected from the nozzle tip for shaping in Step S460 to the control device 11 in the same manner as in Step S430. The control device 11 records the material information and the nozzle information transmitted from the control unit 300C in association with each other in the system memory portion 14 in the same manner as in Step S430.

In Step S480, the control unit 300C updates the cumulative ejection amount by executing the cumulative ejection amount updating process shown in FIG. 18 in the same manner as in Step S440. In the cumulative ejection amount updating process executed in Step S480, the control unit 300C calculates a new cumulative ejection amount by adding the ejection amount of the material ejected in the purging step of Step S460 to the cumulative ejection amount acquired in Step S441 in Step S442 in FIG. 18. Step S490 in FIG. 16 is the same as Step S190 in FIG. 6, and therefore, the description thereof will be omitted.

According to the three-dimensional shaping system 10 of this embodiment described above, the nozzle tip 60 has the shield 68 for suppressing heat transfer to the stacked material from the heating block 90, and the communication unit transmits the nozzle information of the nozzle tip for shaping and the material information to the control device 11, and the control device 11 records the material information and the nozzle information in association with each other. Therefore, by the shield 68, heat transfer to the stacked material from the heating block 90 is suppressed so as to suppress deformation of the three-dimensional shaped article. Further, the possibility that one nozzle tip 60 ejects multiple materials can be reduced based on the material information associated with the nozzle information of the nozzle tip for shaping, and therefore, clogging of the nozzle tip 60 can be suppressed.

In other embodiments, the control unit 300C may, for example, perform a block difference determination process in the same manner as the three-dimensional shaping process in the second embodiment shown in FIG. 9. In this case, the control unit 300C can acquire the nozzle information in the same manner as in Step S405 in FIG. 18, and transmit the acquired nozzle information and the block information to the control device 11 prior to Step S205 in FIG. 9. The control device 11 can receive both information transmitted from the control unit 300C, and record both information in association with each other in the system memory portion 14. The control unit 300C can execute the block difference determination process based on both information associated with each other by the control device 11. Further, the control unit 300C may, for example, perform an apparatus difference determination process in the same manner as the three-dimensional shaping process in the third embodiment shown in FIG. 11. In this case, the control unit 300C transmits the nozzle information and the apparatus information to the control device 11, and can execute the apparatus difference determination process based on both information associated with each other by the control device 11.

### F. Other Embodiments

(F-1) In the above embodiment, the control unit 300 records the nozzle tip for shaping and the material information of the material ejected in a state where the nozzle tip 60 is attached to the heating block 90 for the first time in association with each other. On the other hand, the control unit 300 need not record the nozzle tip for shaping and the material information of the material ejected in a state where the nozzle tip 60 is attached to the heating block 90 for the first time in association with each other. For example, the control unit 300 may record the nozzle tip 60 and the material information in association with each other in advance when the nozzle tip 60 is attached to the heating block 90 and before the nozzle tip 60 ejects the material. Even in this case, for example, by executing the material difference determination shown in FIG. 7 by the control unit 300, the possibility that the nozzle tip 60 ejects a material other than the material associated in advance can be reduced.

(F-2) In the above embodiment, the control unit 300 records the nozzle tip for shaping and the cumulative ejection amount in association with each other. On the other hand, the control unit 300 need not record the nozzle tip for shaping and the cumulative ejection amount in association with each other.

(F-3) In the above embodiment, the control unit 300 notifies that the apparatus is in the material difference state by controlling the notification portion 400. On the other hand, the control unit 300 need not notify that the apparatus is in the material difference state by controlling the notification portion 400. For example, the control unit 300 need only display the material information associated with the nozzle tip for shaping on an output device such as a liquid crystal panel. In this case, the notification portion 400 need not be provided. Even in such a configuration, the possibility that one nozzle tip 60 ejects multiple materials can be reduced based on the material information associated with the nozzle tip for shaping.

(F-4) In the above embodiment, the control unit 300 records the material information in the memory portion 66 of the nozzle tip for shaping. On the other hand, the control unit 300 need not record the material information in the memory portion 66 of the nozzle tip for shaping. For example, the control unit 300 may record the nozzle information and the material information in association with each other in an unillustrated auxiliary memory device of the control unit 300. More specifically, for example, when the memory portion 66 of the nozzle tip 60 stores the nozzle information, the control unit 300 acquires the nozzle information from the memory portion 66 of the nozzle tip for shaping and may record the acquired nozzle information and the material information in association with each other in the auxiliary memory device. Further, for example, the nozzle information of the nozzle tip for shaping may be input by a user through an unillustrated input device or the like. In this case, the control unit 300 acquires the input nozzle information and may record the acquired nozzle information and the material information in association with each other in the auxiliary memory device. Moreover, in this case, the nozzle tip 60 need not include the memory portion 66. Further, similarly, the control unit 300 need not record the block information in the memory portion 66 of the nozzle tip for shaping.

(F-5) In the above embodiment, the memory portion 66 is located between the nozzle opening 63 and the shield 68 in the Z direction along the nozzle flow channel 61. On the other hand, the memory portion 66 need not be located between the nozzle opening 63 and the shield 68 in the Z direction.

(F-6) In the above fourth embodiment, the nozzle flow channel 61 of the tip for a soluble support is shorter than the nozzle flow channel 61 of the main tip. On the other hand, the nozzle flow channel 61 of the tip for a soluble support may have the same length as the nozzle flow channel 61 of the main tip, or may be longer than the nozzle flow channel 61 of the main tip. Further, in a form other than the fourth embodiment, the tip for a soluble support may be used.

(F-7) In the above embodiment, the material data designate the ejection portion 100 that ejects the material in each shaping path, thereby determining the type of material in the shaping path. On the other hand, the material data may, for example, directly designate the material in each shaping path.

(F-8) In the above embodiment, the control unit 300 executes the purging process according to the purge data. On the other hand, the control unit 300 need not execute the purging process according to the purge data. For example, when the shaping path and the material data for performing ejection of the material corresponding to the purging process are included in the shaping data, the control unit 300 may perform purging according to the shaping data without separately executing the purging process. Further, the control unit 300 need not perform purging in the three-dimensional shaping process.

(F-9) In the above embodiment, the material data designate the volume of the material to be ejected per unit movement amount, thereby determining the ejection amount of the material. On the other hand, the material data need not designate the volume of the material. For example, the material data may designate the weight of the material to be ejected per unit movement amount or may designate the line width or the like of the material to be ejected.

(F-10) In the above embodiment, the cumulative ejection amount is recorded as the volume of the material. On the other hand, the cumulative ejection amount need not be recorded as the volume of the material. For example, the cumulative ejection amount may be recorded as the weight of the material.

(F-11) In the above embodiment, the three-dimensional shaping apparatus 5 includes two ejection portions 100. On the other hand, the three-dimensional shaping apparatus 5 may include only one ejection portion 100 or may include three or more ejection portions 100.

(F-12) In the above fifth embodiment, the memory portion 66 stores the nozzle information. On the other hand, the memory portion 66 need not store the nozzle information. For example, the nozzle information of the nozzle tip for shaping may be input by a user through an unillustrated input device or the like. In this case, the control unit 300C that functions as the communication unit acquires the input nozzle information, and can transmit the material information and the acquired nozzle information to the control device 11. Further, in this case, the nozzle tip 60 need not include the memory portion 66.

(F-13) In the above fifth embodiment, the communication unit transmits the ejection amount information to the control device 11. On the other hand, the communication unit need not transmit the ejection amount information to the control device 11. Further, the control device 11 need not record the nozzle information and the ejection amount information in association with each other.

### G. Other Aspects

The present disclosure is not limited to the above-mentioned embodiments, but can be realized in various aspects without departing from the gist thereof. For example, the present disclosure can also be realized in the following aspects. The technical features in the above-mentioned embodiments corresponding to technical features in the respective aspects described below may be appropriately replaced or combined for solving part or all of the problems of the present disclosure or achieving part or all of the effects of the present disclosure. Further, the technical features may be appropriately deleted unless they are described as essential features in the present specification.

(1) According to the first aspect of the present disclosure, a three-dimensional shaping apparatus is provided. The three-dimensional shaping apparatus includes a heating block that has a heater and is provided with a through hole, a nozzle tip that is provided with a nozzle flow channel having a nozzle opening and that is detachably attached to the through hole of the heating block, a material conveying mechanism that conveys a material to the nozzle flow channel of a nozzle tip for shaping being the nozzle tip attached to the heating block, a stage at which the material plasticized by heat of the heating block is ejected from the nozzle opening of the nozzle tip for shaping and stacked, and a control unit. The nozzle tip has a shield for suppressing transfer of heat of the heating block to the material stacked at the stage, and the control unit records the nozzle tip for shaping and material information regarding a type of the material in association with each other.

According to such an aspect, transfer of heat of the heating block to the material stacked at the stage is suppressed by the shield so as to suppress deformation of a three-dimensional shaped article. Further, the possibility that one nozzle tip ejects multiple materials can be reduced based on the material information associated with the nozzle tip for shaping, and therefore, clogging of the nozzle tip can be suppressed.

(2) In the three-dimensional shaping apparatus of the above aspect, the control unit may record the nozzle tip for shaping and the material information of the material ejected in a state where the nozzle tip for shaping is attached to the heating block for the first time in association with each other. According to such an aspect, the possibility that the nozzle tip for shaping ejects a material other than the material ejected in a state where the nozzle tip for shaping is attached to the heating block for the first time can be reduced, and therefore, clogging of the nozzle tip can be suppressed.

(3) In the three-dimensional shaping apparatus of the above aspect, the control unit may record the nozzle tip for shaping and a cumulative ejection amount of the material ejected after the nozzle tip for shaping is attached to the heating block for the first time in association with each other. According to such an aspect, not only the material information associated with the nozzle tip for shaping, but also the cumulative ejection amount of the material can be obtained. Therefore, for example, by replacing the nozzle tip for shaping in advance according to the cumulative ejection amount of the material, nozzle clogging during shaping of the three-dimensional shaped article can be suppressed.

(4) In the three-dimensional shaping apparatus of the above aspect, the apparatus may further include a notification portion, and when the apparatus is in a material difference state where the type of the material recorded in association with the nozzle tip for shaping and the type of the material to be ejected from the nozzle tip for shaping are different, the control unit may control the notification portion to notify that the apparatus is in the material difference state. According to such an aspect, for example, by replacing the nozzle tip for shaping with another nozzle tip based on the notified information, the material difference state can be eliminated, and the possibility that one nozzle tip ejects multiple materials can be further reduced.

(5) In the three-dimensional shaping apparatus of the above aspect, the nozzle tip may have a memory portion, and the control unit may record the material information in the memory portion of the nozzle tip for shaping. According to such an aspect, by recording the material information in the memory portion of the nozzle tip for shaping, the nozzle tip for shaping and the material information can be associated with each other.

(6) In the three-dimensional shaping apparatus of the above aspect, the nozzle tip may have a memory portion, and the control unit may record apparatus information regarding information for identifying the three-dimensional shaping apparatus in the memory portion of the nozzle tip for shaping. According to such an aspect, the possibility that one nozzle tip is attached to multiple three-dimensional shaping apparatuses can be reduced, and therefore, the nozzle tip is less likely to be affected by differences in temperature conditions or the like among apparatuses or individual differences among apparatuses or the like, and clogging of the nozzle tip can be further suppressed.

(7) In the three-dimensional shaping apparatus of the above aspect, the memory portion may be located between the nozzle opening and the shield in a direction along the nozzle flow channel. According to such an aspect, transfer of heat of the heating block to the memory portion is suppressed by the shield in a state where the nozzle tip is attached to the heating block.

(8) In the three-dimensional shaping apparatus of the above aspect, the control unit may record the nozzle tip for shaping and block information regarding information for identifying the heating block in association with each other. According to such an aspect, the possibility that one nozzle tip is attached to multiple heating blocks can be reduced, and therefore, clogging of the nozzle tip can be further suppressed.

(9) In the three-dimensional shaping apparatus of the above aspect, the nozzle tip may be a main tip that ejects a shaping material for shaping a three-dimensional shaped article as the material, or a tip for a soluble support that ejects a soluble support material as the material. According to such an aspect, when the nozzle tip is the main tip, the three-dimensional shaped article can be shaped by ejecting the shaping material from the nozzle tip. Further, when the nozzle tip is the tip for a soluble support, the shape of the shaped article in the middle of shaping can be held by ejecting the soluble support material from the nozzle tip.

(10) In the three-dimensional shaping apparatus of the above aspect, the nozzle flow channel of the tip for a soluble support may be shorter than the nozzle flow channel of the main tip. According to such an aspect, when the nozzle tip is the tip for a soluble support, deposition of the material in the nozzle flow channel is suppressed, and nozzle clogging in the nozzle tip is suppressed. Further, when the nozzle tip is the main tip, plasticization of the shaping material in the nozzle flow channel is accelerated.

(11) According to the second aspect of the present disclosure, a three-dimensional shaping system including multiple three-dimensional shaping apparatuses and a control device that controls the multiple three-dimensional shaping apparatuses is provided. In the three-dimensional shaping system, each three-dimensional shaping apparatus includes a heating block that has a heater and is provided with a through hole, a nozzle tip that is provided with a nozzle flow channel having a nozzle opening and that is detachably attached to the through hole of the heating block, a material conveying mechanism that conveys a material to the nozzle flow channel of a nozzle tip for shaping being the nozzle tip attached to the heating block, a stage at which the material plasticized by heat of the heating block is ejected from the nozzle opening of the nozzle tip for shaping and stacked, and a communication unit that communicates with the control device. The nozzle tip has a shield for suppressing transfer of heat of the heating block to the material stacked at the stage, the communication unit transmits nozzle information regarding information for identifying the nozzle tip for shaping and material information regarding a type of the material to the control device, and the control device records the material information and the nozzle information in association with each other.

According to such an aspect, by the shield, transfer of heat of the heating block to the material stacked at the stage is suppressed so as to suppress deformation of the three-dimensional shaped article. Further, the possibility that one nozzle tip ejects multiple materials can be reduced based on the material information associated with the nozzle information of the nozzle tip for shaping, and therefore, clogging of the nozzle tip can be suppressed.

The present disclosure can also be realized in various forms other than the three-dimensional shaping apparatus and the three-dimensional shaping system. For example, it can be realized in forms such as a method for producing a three-dimensional shaped article and a program for shaping a three-dimensional shaped article.

What is claimed is:

1. A three-dimensional shaping apparatus, comprising:
a heating block that has a heater and is provided with a through hole;
a nozzle tip that is provided with a nozzle flow channel having a nozzle opening and that is detachably attached to the through hole of the heating block;
a material conveying mechanism that conveys a material to the nozzle flow channel of a nozzle tip for shaping being the nozzle tip attached to the heating block;
a stage at which the material plasticized by heat of the heating block is ejected from the nozzle opening of the nozzle tip for shaping and stacked; and
a control unit, wherein
the nozzle tip has a shield for suppressing transfer of heat of the heating block to the material stacked at the stage, and
the control unit records the nozzle tip for shaping and material information regarding a type of the material in association with each other.

2. The three-dimensional shaping apparatus according to claim 1, wherein
the control unit records the nozzle tip for shaping and the material information of the material ejected in a state where the nozzle tip for shaping is attached to the heating block for the first time in association with each other.

3. The three-dimensional shaping apparatus according to claim 1, wherein
the control unit records the nozzle tip for shaping and a cumulative ejection amount of the material ejected after the nozzle tip for shaping is attached to the heating block for the first time in association with each other.

4. The three-dimensional shaping apparatus according to claim 1, further comprising a notification portion, wherein
when the apparatus is in a material difference state where the type of the material recorded in association with the nozzle tip for shaping and the type of the material to be ejected from the nozzle tip for shaping are different, the control unit controls the notification portion to notify that the apparatus is in the material difference state.

5. The three-dimensional shaping apparatus according to claim 1, wherein
the nozzle tip has a memory portion, and
the control unit records the material information in the memory portion of the nozzle tip for shaping.

6. The three-dimensional shaping apparatus according to claim 1, wherein
the nozzle tip has a memory portion, and
the control unit records apparatus information regarding information for identifying the three-dimensional shaping apparatus in the memory portion of the nozzle tip for shaping.

7. The three-dimensional shaping apparatus according to claim 5, wherein
the memory portion is located between the nozzle opening and the shield in a direction along the nozzle flow channel.

8. The three-dimensional shaping apparatus according to claim 1, wherein
the control unit records the nozzle tip for shaping and block information regarding information for identifying the heating block in association with each other.

9. The three-dimensional shaping apparatus according to claim 1, wherein
the nozzle tip is a main tip that ejects a shaping material for shaping a three-dimensional shaped article as the material, or a tip for a soluble support that ejects a soluble support material for supporting the three-dimensional shaped article as the material.

10. The three-dimensional shaping apparatus according to claim 9, wherein
the nozzle flow channel of the tip for a soluble support is shorter than the nozzle flow channel of the main tip.

11. A three-dimensional shaping system, comprising a three-dimensional shaping apparatus and a control device, wherein
the three-dimensional shaping apparatus includes
a heating block that has a heater and is provided with a through hole,
a nozzle tip that is provided with a nozzle flow channel having a nozzle opening and that is detachably attached to the through hole of the heating block,
a material conveying mechanism that conveys a material to the nozzle flow channel of a nozzle tip for shaping being the nozzle tip attached to the heating block,
a stage at which the material plasticized by heat of the heating block is ejected from the nozzle opening of the nozzle tip for shaping and stacked, and
a communication unit that communicates with the control device,
the nozzle tip has a shield for suppressing transfer of heat of the heating block to the material stacked at the stage,
the communication unit transmits nozzle information regarding information for identifying the nozzle tip for shaping and material information regarding a type of the material to the control device, and
the control device records the material information and the nozzle information in association with each other.
